(19) United States
(12) Patent Application Publication
(10) Pub. No.: US 2014/0011954 A1
(43) Pub. Date: Jan. 9, 2014

(54) METHOD FOR PRODUCING POROUS SILICA PARTICLE, RESIN COMPOSITION FOR ANTIREFLECTION COATING, AND ARTICLE AND ANTIREFLECTION FILM HAVING ANTIREFLECTION COATING

(71) Applicants: Hiroki Tokoro, Ichihara-shi (JP); Youzou Yamashina, Ichihara-shi (JP); Kiyofumi Takano, Ichihara-shi (JP); Tomoyo Shimogaki, Ichihara-shi (JP); Minoru Tabuchi, Kyoto-shi (JP); Tomoe Deguchi, Kyoto-shi (JP)

(72) Inventors: Hiroki Tokoro, Ichihara-shi (JP); Youzou Yamashina, Ichihara-shi (JP); Kiyofumi Takano, Ichihara-shi (JP); Tomoyo Shimogaki, Ichihara-shi (JP); Minoru Tabuchi, Kyoto-shi (JP); Tomoe Deguchi, Kyoto-shi (JP)

(73) Assignee: DIC CORPORATION, Tokyo (JP)

(21) Appl. No.: 13/980,358

(22) PCT Filed: Jan. 19, 2012
(86) PCT No.: PCT/JP2012/051030

§ 371 Date: Sep. 26, 2013

(30) Foreign Application Priority Data
Jan. 21, 2011 (JP) 2011-010877

(51) Int. Cl. C09D 5/00

(52) U.S. Cl. CPC C09D 5/006
USPC 524/850; 423/335; 556/412

(57) ABSTRACT

An object of the present invention is to provide a method for producing porous silica particles having a small particle diameter in high yield relative to a volume of a reaction solution. In order to achieve the object, the present invention provides a method for producing porous silica particles having pores on the surfaces thereof, the method including a step of adding a mixed solution (solution A) containing tetraalkoxysilane, alkylamine, and alcohol to a mixed solution (solution B) containing ammonia, alcohol, and water and performing a hydrolysis and condensation reaction of the tetraalkoxysilane to produce silica particles, and a step of removing the alkylamine from the silica particles.

### TECHNICAL FIELD

The present invention relates to a production method capable of producing porous silica particles in a larger amount relative to the mass of a reaction system (producing in high yield), the silica particles having a small particle diameter of, for example, 100 to 250 nm, and pores on the surfaces thereof.

### BACKGROUND ART

Porous silica particles are silica particles having pores on the surfaces thereof. The porous silica particles having a pore size in a mesopore region of 2 to 50 nm are referred to as “mesoporous silica particles”. The porous silica particles contain air in the pores thereof and have excellent optical and electrical properties, and are thus utilized as materials for an antireflection coating, an interlayer insulating film, and the like. When the porous silica particles are used for an antireflection coating, the particles can be used as materials for low-refractive-index layers by using the property of low refractive index of the porous silica particles. The ideal thickness of the low-refractive-index layers which efficiently prevents reflection of visible light is generally 100 to 250 nm. Therefore, when the porous silica particles are used for an antireflection coating, the porous silica particles are required to have an average particle diameter equivalent to or smaller than this thickness.

A known method for producing the porous silica particles is referred to as a “HMS method”. Specifically, the HMS method is, for example, a method in which tetraethoxysilane is added to a mixed solution containing ethanol and water as solvents and alkylamine serving as a pore template, such as dodecylamine or the like, the tetraethoxysilane is self-condensed to produce silica particles, and then the template is removed from the particles by washing with a solvent such as toluene or acetone or firing at a temperature of about 300° C. to 800° C. (refer to, for example, Patent Literature 1). The porous silica particles produced by this method generally have a particle diameter of as relatively large as about 1 μm. Therefore, the porous silica particles produced by the HMS method have the problem of too large size for application to antireflection coatings.

Another method for producing porous silica particles is a method in which a mixture of alcohol, an anionic surfactant which possibly aggregates a hydrolysate of a silane compound, and an alkali compound, such as ammonia water, amine, or the like, which functions as a catalyst for hydrolysis is added to a mixture of water and a silane compound such as tetramethoxysilane, trimethoxysilane, or the like to produce an aqueous mixed solution containing a silica particle precursor, and then sodium aluminate is added to the aqueous mixed solution (refer to, for example, Patent Literature 2). Unlike in the HMS method, this method does not use a pore template. At the time when the silica particle precursor is produced, the precursor is considered not to be completely cured up to the inside, and sodium aluminate which dissolves silica particles permeates into the silica particle precursor and elutes part of silica-based components to the outside of particles, thereby producing porous silica particles. However, also, silica particles produced by the method disclosed in Patent Literature 2 have a particle diameter of as large as 4 to 8 μm and thus cannot be used in application to antireflection coatings.

There is proposed a method for producing porous silica particles having a small particle diameter, in which tetraethoxysilane and amino group-containing alkoxysilane are added to a mixed solution containing a quaternary ammonium salt cationic surfactant serving as a pore template, water, polyhydric alcohol having two or more hydroxyl groups, and ammonia water, co-hydrolysis reaction between tetraethoxysilane and amino group-containing alkoxysilane is performed to produce silica particles, and then the quaternary ammonium salt cationic surfactant is extracted and removed from the silica particles by immersing the silica particles in an acid solution (refer to, for example, Patent Literature 3). The method of Patent Literature 3 can produce silica particles having pores with a diameter of about 1 to 10 nm and a particle diameter of about 20 to 200 nm. However, the production method described in Patent Literature 3 is required to be performed under a condition where the amount of the mixed solution overwhelmingly exceeds the amount of alkoxysilane, specifically under a condition where the total mass of water and polyhydric alcohol is about 120 times as large as 1 part by mass of alkoxysilane, and thus the production method has the problem of low yield of porous silica fine particles and very low production efficiency.

### CITATION LIST

### Patent Literature

PTL 1: Japanese Unexamined Patent Application Publication No. 2007-185656
PTL 2: Japanese Unexamined Patent Application Publication No. 2006-176343
PTL 3: Japanese Unexamined Patent Application Publication No. 2008-280193

### SUMMARY OF INVENTION

### Technical Problem

A problem to be solved by the present invention is to provide a production method capable of producing, in high yield, porous silica particles having a particle diameter of as small as 100 to 250 nm, provide a resin composition for an antireflection coating using porous silica particles produced by the production method, and provide an article, particularly, an antireflection film, having an antireflection coating formed using the composition.

### Solution to Problem

As a result of intensive research, the inventors of the present invention found that particles of 100 to 250 nm having pores in a mesopore region can be produced in high yield by mixing tetraalkoxysilane used as a silane compound with alcohol and alkylamine, not with water as described in Patent Literature 2, adding the resultant mixture to a mixed solution containing alcohol, water, and ammonia, performing a hydrolysis and condensation reaction of the tetraalkoxysilane, and then firing the resultant silica particles to remove organic substances in the silica particles, leading to the achievement of the present invention.

The present invention provides a method for producing porous silica particles having pores on the surfaces thereof, the method including a step of adding a mixed solution (solution A) containing tetraalkoxysilane, alkylamine, and alcohol to a mixed solution (solution B) containing ammonia, alcohol, and water and performing a hydrolysis and condensation reaction of the tetraalkoxysilane to produce silica particles, and a step of removing the alkylamine from the silica particles.

Also, the present invention provides a resin composition for an antireflection coating, the resin composition including porous silica particles produced by a method for producing porous silica particles, which includes a step of surface-modifying the resultant silica particles after the step of removing alkylamine from the silica particles in the above-described production method, and a binder resin. Further the present invention provides an article including an antireflection coating formed by coating with the composition for an antireflection coating, and further provides an antireflection film including an antireflection coating formed by coating at least one surface of a base film with the composition for an antireflection coating.

### Advantageous Effects of Invention

By using the production method of the present invention, porous silica particles having a particle diameter of as small as, for example, 100 to 250 nm, can be produced. Also, the production method of the present invention exhibits a high yield of the porous silica particles relative to the volume of a reaction solution, and exhibits a good production efficiency of the porous silica particles. The porous silica particles produced by the production method of the present invention have pores with an average pore diameter in a range of 1 to 4 nm on the surfaces of the particles, and thus can be used for an antireflection coating by using a low refractive index due to the air present in the pores. In addition, the porous silica particles have a low dielectric constant and thus can be used as a material for interlayer insulating films of a semiconductor and a printed circuit board. Besides these, the porous silica particles can be used for various catalysts each including a metal catalyst or optical catalyst supported in pores, materials for ink jet ink or toner receiving layers, fillers of various coating materials, molecular sensors using the property of adsorbing specified molecules, hydrogen gas-separating and absorbing materials, heat insulators using a heat insulation property due to air contained in pores, light-diffusion films employing light diffusion in backlight units of a liquid crystal display and the like, printing original plates, antibacterial materials each including an antibacterial agent supported in pores, an absorbing material, filter material, and separation film employing adsorptivity of pores, wallpaper imparted with a humidity conditioning property using water absorption and moisture absorption by pores, various cosmetics, a colorant and color-conversion filter including a dye supported in pores and having high weather resistance, various batteries such as a fuel cell including an electrolyte supported in pores, an ultraviolet shielding material including an ultraviolet shielding agent, such as zinc oxide or the like, supported in pores, a liquid crystal alignment film, etc.

The composition for an antireflection coating of the present invention uses the porous silica particles which is a low-refractive-index material and which have high mechanical physical properties and thus have the advantage that the antireflection property is not degraded during preparation and coating because the porous silica particles are not fractured even by dispersion treatment with high force applied during preparation or by using a coating apparatus which applies a pressure to a coating material during coating. Therefore, any coating method can be used for forming an antireflection coating on a surface of an article, and thus an antireflection coating having the stable excellent antireflection property can be formed on the surface of the article.

In particular, the antireflection film formed by forming the antireflection coating using the composition for an antireflection coating of the present invention on a film used as a substrate includes a low-refractive-index layer with a thickness controlled so that antireflection can be efficiently realized on the outermost surface, and thus has the excellent antireflection property. Therefore, the antireflection film can be used for preventing a decrease in contrast and image reflection which are caused by reflection of external light from surfaces of display screens of image display devices such as a liquid crystal display (LCD), an organic EL display (OELD), a plasma display (PDP), a surface-conduction electron-emitter display (SED), a field emission display (FED), and the like.

### BRIEF DESCRIPTION OF DRAWINGS

FIG. 1 is a photograph obtained by observing, at 50,000×, porous silica particles produced in Example 1 with a field emission-type scanning electron microscope (FE-SEM).

FIG. 2 is a photograph obtained by observing, at 50,000×, porous silica particles produced in Example 2 with a field emission-type scanning electron microscope (FE-SEM).

FIG. 3 is a photograph obtained by observing, at 50,000×, porous silica particles produced in Example 3 with a field emission-type scanning electron microscope (FE-SEM).

FIG. 4 is a photograph obtained by observing, at 50,000×, porous silica particles produced in Example 4 with a field emission-type scanning electron microscope (FE-SEM).

FIG. 5 is a photograph obtained by observing, at 50,000×, a section of an antireflection coating formed using a composition for an antireflection coating of Example 12 with a field emission-type scanning electron microscope (FE-SEM).

FIG. 6 is a photograph obtained by observing, at 50,000×, a section of an antireflection coating formed using a composition for an antireflection coating of Example 13 with a field emission-type scanning electron microscope (FE-SEM).

FIG. 7 is a photograph obtained by observing, at 100,000×, a section of an antireflection coating formed using a composition for an antireflection coating of Example 14 with a field emission-type scanning electron microscope (FE-SEM).

FIG. 8 is a photograph obtained by observing, at 50,000×, a section of an antireflection coating formed using a composition for an antireflection coating of Example 15 with a field emission-type scanning electron microscope (FE-SEM).

### DESCRIPTION OF EMBODIMENTS

A method for producing porous silica particles of the present invention includes a step of adding a mixed solution (solution A) containing tetraalkoxysilane, alkylamine, and alcohol to a mixed solution (solution B) containing ammonia, alcohol, and water and performing a hydrolysis and condensation reaction of the tetraalkoxysilane to produce silica particles, and a step of firing the silica particles.

Examples of the tetraalkoxysilane which is a constituent component of the solution A and used as a raw material of the porous silica particles include tetramethoxysilane, tetraethoxysilane, tetrapropoxysilane, and the like. Among these, tetramethoxysilane is preferred in view of high reactivity. These tetraalkoxysilanes can be used alone or in combination of two or more.

The alkylamine which is a constituent component of the solution A functions as a so-called template for forming pores on the surfaces of the silica particles, and thus the number, size, and shape of pores can be controlled according to the type and amount of the alkylamine added. Also, the alkylamine functions, together with ammonia described below, as a catalyst for the hydrolysis and condensation reaction of the tetraalkoxysilane. An amine compound containing an alkyl group having 6 to 18 carbon atoms is preferred as the alkylamine because of high solubility in an alcohol used as a solvent of the solution A and the solution B and the ease of production of porous silica particles having a particle diameter of, for example, 100 to 250 nm. Examples of the amine compound containing an alkyl group having 6 to 18 carbon atoms include octylamine, decylamine, laurylamine, tetradecylamine, oleylamine, and the like. These alkylamines can be used alone or in combination of two or more.

In order to increase the number of pores of the silica particles, for example, a ratio [tetraalkoxysilane/alkylamine] of tetraalkoxysilane to alkylamine described below may be decreased. Also, in order to increase the size of pores of the silica particles, for example, alkylamine having a large number of carbons may be used.

The alcohol which is a constituent component of the solution A functions as a solvent and exhibits the effect of facilitating the preparation of the uniformly mixed solution A by dissolving the alkylamine. An alcohol miscible with water is preferred. Further, an alcohol having the same number of carbons as that of an alkoxy site of the tetraalkoxysilane used is particularly preferred from the viewpoint of preventing complication of a reaction system due to an exchange reaction between alkoxysilane and alcohol. Specific examples of the alcohol include methanol, ethanol, propanol, and the like.

The ratio [tetraalkoxysilane/alkylamine] of tetraalkoxysilane to alkylamine in the solution A is preferably in a range of 1/0.05 to 1/5 in terms of molar ratio in order to produce particles having pores on the surface thereof and including spherical primary particles, and the molar ratio is more preferably 1/0.1 to 1/3.0 and still more preferably 1/0.1 to 1/2.0.

The content of the tetraalkoxysilane in the solution A is 10 to 60 parts by mass in 100 parts by mass of the solution A because of high production yield, and the content is more preferably 25 to 45 parts by mass.

The ammonia which is a constituent component of the solution B functions as a catalyst of the hydrolysis and condensation reaction of the tetraalkoxysilane. The ammonia used may be added as ammonia water or introduced as gas into the reaction solution, but the ammonia is preferably used as ammonia water because the using amount can be easily controlled.

For example, the same alcohol as used for preparing the solution A can be used as the alcohol which is a constituent component of the solution B. The same alcohol as or a different alcohol from used for preparing the solution A may be used. In addition, only one type of alcohol or combination of two or more types may be used.

In order to avoid as much as possible contamination of the reaction system with impurities, pure water is preferably used as the water which is a constituent component of the solution B and used as a solvent in the production method of the present invention.

A ratio [ammonia/water] of ammonia to water in the solution B is preferably in a range of 1/1 to 1/20 in terms of molar ratio in order to produce particles having pores on the surfaces thereof and including spherical primary particles. The molar ratio of ammonia to water is more preferably 1/2.5 to 1/20 because a reaction operation can be easily performed using ammonia water.

The mass of water in the solution B is preferably 1 to 40 parts by mass, more preferably 2 to 30 parts by mass, relative to 100 parts by mass of the solution B because the particle diameter of the porous silica fine particles can be easily controlled.

The method for producing the porous silica particles having pores on the surface thereof according to the present invention include a step of adding the solution A to the solution B and performing a hydrolysis and condensation reaction of the tetraalkoxysilane to produce silica particles (abbreviated as “step 1” hereinafter), and a step of removing the alkylamine from the silica particles (abbreviated as “step 2” hereinafter).

The steps are described in detail below. The step 1 is a step of forming the silica particles by hydrolyzing and condensing the tetraalkoxysilane. When the solution A is mixed with the solution B, the solution A is preferably mixed with the solution B so that the amount of ammonia functioning as the catalyst of the hydrolysis and condensation reaction of the tetraalkoxysilane is such an amount as to adjust a mixed solution (reaction system) of the solutions A and B in a pH range of 8 to 12, more preferably in a pH range of 9 to 11, because spherical primary particles can be easily formed.

When the solution A is added to the solution B, for example, the solution A may be added dropwise from above to a vessel containing the solution B, or the solution A may be added to the solution B by flowing out the solution A from a conduit nozzle placed in a vessel containing the solution B. Also, when the solution A is added to the solution B, the solution A may be injected in the solution B while the solution B is stirred.

The temperature during mixing of the solution A and the solution B is preferably in a range of 5° C. to 80° C. for achieving solubility of the reaction raw materials in the reaction system and producing particles including spherical primary particles.

The time required for injection of the solution A into the solution B is preferably in a range of 0 to 240 minutes, more preferably in a range of 30 to 150 minutes. The time of 0 minutes represents that the solution A is poured into the solution B at once. In addition, after the injection of the solution A, further stirring reaction is preferably performed in a temperature range of 5 to 80° C. for 10 minutes or more. In the step 1, the silica particles as a source of the porous silica particles are produced.

After the solution A is added to the solution B in the step 1, a mixed solution (solution A′) containing tetraalkoxysilane and alcohol is further added to produce porous silica particles in which entering of other compounds, for example, the solvent and the resin, into the pores can be suppressed. The solution A′ may be added rapidly after the solution A is added to the solution B, or the solution A′ may be added after still standing or stirring after the solution A is added to the solution B.

In the step 2, the alkylamine is removed from the silica particles produced in the step 1. Examples of a method for removing the alkylamine include a method of washing the silica particles with an acid, a method of spraying the silica particles into a high temperature, a method of firing the silica particles, and the like.

When the alkylamine is removed from the silica particles, the silica particles may be previously washed. A method of washing the silica particles includes, for example, first centrifugally removing the silica particles from the reaction solution produced in the step 1. Then, an alcohol is added to the silica particles and stirred to prepare a suspension, and the resultant suspension is again centrifuged to remove the silica particles. This step is performed several times to wash the silica particle with the alcohol. The alcohol used is preferably the same type as the alcohol used for preparing the solution A and the solution B. A method for removing the silica particles from the reaction solution and the alcohol suspension is not limited to centrifugation, and for example, ultrafiltration may be used. The washing step may be continuously performed using an ultrafilter.

Examples of an acid used in the method of washing the silica particles with an acid include hydrochloric acid, nitric acid, sulfuric acid, acetic acid, and the like. Among these acids, an inorganic acid is preferred because a neutralized salt is water-soluble.

When the silica particles are washed with an acid, washing is preferably performed in the presence of an alcohol other than water. In this case, the alcohol used may be the same type of alcohol as used in the solution A and the solution B. Further, the alkylamine is preferably extracted under heating, and the temperature range is preferably near the boiling point of the alcohol used because of high extraction efficiency.

When the silica particles are sprayed in a high temperature, for example, a commercially available spray dryer capable of spraying the silica particles in an atmosphere of about 270° C. to 800° C. may be used. When the silica particles are sprayed in a high temperature, the silica particles may be previously washed with the alcohol or acid.

In the method of firing the silica particles, the silica particles may be previously washed with the alcohol or acid.

If required, after the washing, a drying temperature at which the silica particles are dried is preferably in a range of 60° C. to 150° C., more preferably in a range of 80° C. to 130° C.

The dried silica particles are fired to remove all organic substances remaining in the silica particles. As a result, the alkylamine used as the template is removed. The preferred conditions for the firing step include a firing temperature in a range of 400° C. to 1,000° C., more preferably in a range of 500° C. to 800° C. The firing time is preferably 30 minutes or more, more preferably 1 hour or more. Since all organic substances remaining in the silica particles can be removed in the firing step, the porous silica particles having pores on the surfaces of the silica particles can be produced.

When the particles after firing are aggregated, the particles are preferably ground. Examples of a grinder used for grinding include a ball mill, a colloid mill, a conical mill, a disk mill, an edge mill, a flour mill, a hammer mill, a mortar, a pellet mill, a jet mill, a vertical shaft impactor (VSI) mill, a wiley mill, a roller mill, and the like.

In addition, hydroxyl groups of silanol groups present on the surfaces of the porous silica particles produced after the firing step are preferably substituted with hydrophobic groups by surface treatment with a surface treatment agent because self-aggregation of the silica particles can be prevented and dispersibility in an organic solvent and a resin can be improved. A method for surface treatment is, for example, a method of immersing porous silica in a solution prepared by dissolving the surface treatment agent in a solvent, and if required, heating the particles. Examples of the solvent used in the surface treatment include methanol, ethanol, isopropyl alcohol, benzene, toluene, xylene, N,N-dimethylformamide, hexamethyldisiloxane, and the like. Examples of the surface treatment agent used for surface modification include silane compounds and silazane compounds, such as methyltrimethoxysilane, dimethyldimethoxysilane, phenyltrimethoxysilane, methyltriethoxysilane, dimethyldiethoxysilane, phenyltriethoxysilane, hexyltrimethoxysilane, hexyltriethoxysilane, decyltrimethoxysilane, trifluoropropyltrimethoxysilane, hexamethyldisiloxane, trimethylmethoxysilane, ethyltrimethoxysilane, trimethylethoxysilane, dimethyldiethoxysilane, hexamethyldisilazne, “Dow Corning 2634 Coating” (manufactured by Toray Dow Corning. Co., Ltd.) which is perfluoropolyether having methoxysilane terminals, “Fluorolink S10” (manufactured by Solvay Solexis Inc.) which is a perfluoropolyether having ethoxysilane terminals, and the like. In particular, the porous silica particles surface-modified with the silazane compound can be produced by surface treatment with the silazane compound.

Specifically, the porous silica particles surface-modified with the silazane compound can be produced by adding, to the production method of the present invention, a step of surface-modifying the porous silica particles produced after the step 2 (the step of removing the alkylamine from the silica particles). The silazane compound used is preferably hexamethyldisilazane.

When the surfaces of the porous silica particles are modified with the silazane compound, a catalyst is preferably used. Examples of the catalyst include inorganic acids such as hydrochloric acid, sulfuric acid, nitric acid, and the like; organic acids such as oxalic acid, acetic acid, formic acid, methanesulfonic acid, toluenesulfonic acid, and the like; inorganic bases such as sodium hydroxide, potassium hydroxide, ammonia, and the like; organic bases such as triethylamine, pyridine, and the like; and metal alkoxides such as triisopropoxyaluminum, tetrabutoxyzirconium and the like. Among these, an acid catalyst (inorganic acid or organic acid) is used because of good production stability and storage stability of a dispersion of porous silica particles (A). Inorganic acids such as hydrochloric acid, sulfuric acid, and the like; and organic acids such as methanesulfonic acid, oxalic acid, phthalic acid, malonic acid, and acetic acid are preferred, and acetic acid is particularly preferred.

A method for modifying the surfaces of the porous silica particles is, for example, a method in which the porous silica particles are immersed in a solution containing the surface modifying agent dissolved in a solvent and, if required, heated. Examples of the solvent used for the surface modification include methanol, ethanol, isopropylalcohol, benzene, toluene, xylene, N,N-dimethylformamide, acetone, methyl ethyl ketone, methyl isobutyl ketone, and the like.

The amount of the surface modifying agent used for surface-modifying the porous silica particles is preferably in a range of 0.3 to 60 parts by mass, more preferably in a range of 0.5 to 50 parts by mass, relative to 100 parts by mass of the porous silica particles in order to produce the porous silica particles (E) stable as primary particles without secondary aggregation.

Further, at the same time as the surface modification, aggregated particles of the porous silica particles are preferably ground to form a dispersion in a primary particle state.

The porous silica particles can be produced through the steps 1 and 2. The particle shape, average particle diameter, average pore diameter, and specific surface of the resultant porous silica particles can be measured by measurement methods described below.

### [Particle Shape]

The particle shape can be confirmed by observation with a field-emission-type scanning electron microscope (FE-SEM) (for example, “JSM6700” manufactured by JEOL, Ltd.).

### [Average Particle Diameter]

The average particle diameter can be confirmed by observation with a field-emission-type scanning electron microscope (FE-SEM) (for example, “JSM6700” manufactured by JEOL, Ltd.).

### [Average Pore Diameter]

The average pore diameter can be measured with a pore size distribution analyzer (for example, “ASAP2020” manufactured by Shimadzu Corporation).

### [Specific Surface Area]

The specific surface area can be measured by a BET method using a pore size distribution analyzer (for example, “ASAP2020” manufactured by Shimadzu Corporation).

The particle shape, average particle diameter, average pore diameter, and specific surface of the resultant porous silica particles produced by the method for producing porous silica particles of the present invention can be measured by measurement methods described above. The method for producing porous silica particles of the present invention is characterized in that porous silica particles having a substantially spherical appearance can be produced, the average particle diameter can be controlled by adjusting the amount of ammonia used as described above, and the silica particles having an average particle diameter in a range of 50 to 300 nm, preferably 100 to 250 nm, can be produced. Also, the average pore diameter and specific surface area of the porous silica particles can be controlled according to the type and amount of alkylamine used, and the particles with an average pore diameter in a range of 1 to 4 nm and a specific surface area in a range of 40 to 900 m²/g can be produced.

A resin composition for an antireflection coating of the present invention includes porous silica particles [abbreviated as “porous silica particles (E)” hereinafter] and a binder resin (F), the porous silica particles (E) being produced by a production method including a step of surface-modifying, with a surface modifying agent (D), the resultant silica particles after the step of removing the alkylamine from the porous silica particles produced by the production method of the present invention. By using the resin composition for an antireflection coating of the present invention, in particular, a low-refractive-index layer can be simultaneously formed on a high-refractive-index layer by a one-time step of applying, drying, curing on a substrate, the thickness of the low-refractive-index layer can be controlled so as to realize efficient antireflection, and an antireflection coating can be formed without a coating apparatus.

The composition for an antireflection coating of the present invention can be formed into an antireflection layer including the porous silica particles (E) substantially arranged in a monolayer on a surface of a coating film composed of the binder resin (F). In the present invention, an antireflection coating contains both the antireflection layer composed of the porous silica particles (E) and the coating layer substantially composed of only the binder region (F).

In order that the thickness of the antireflection layer composed of the porous silica particles (E) is adjusted to about 100 nm, which permits efficient antireflection, the volume-average diameter of the porous silica particles (E) is preferably in a range of 80 to 150 nm, more preferably in a range of 90 to 120 nm.

The antireflection layer composed of the porous silica particles (E) preferably has a more uniform thickness, and thus the porous silica particles preferably have a narrower particle size distribution. Therefore, a coefficient of variation (CV) which indicates the particle size distribution of the porous silica particles (E) is preferably in a range of 0 to 40%, more preferably in a range of 0 to 35%. In view of the ease of production of the porous silica particles (E), the lower limit of the coefficient of variation is preferably 5%, more preferably 10%, still more preferably 15%, and most preferably 20%. The coefficient of variation is calculated according to formula (1) below, in which a standard deviation is calculated according to formula (2) below. In the formula (2) below, d84% represents a diameter corresponding to a point of 84% in a volume-particle size distribution, and d16% represents a diameter corresponding to a point of 16% in a volume-particle size distribution.

[Math. 1]

Coefficient of variation (%)=standard deviation (nm)/volume-average diameter (nm)×100 (1)

Standard deviation (nm)=(d84% (nm)−d16% (nm))/2 (2)

The porous silica particles (E) having the above-described volume-average diameter and coefficient of variation can be produced by adding the step of surface-modifying the silica particles with the surface modifying agent after the step 2 (the step of removing the alkylamine from the silica particles) as described above in the production method of the present invention. The particle shape and specific surface area of the resultant porous silica particles (E) can be measured by the methods described above, and the volume-average diameter, coefficient of variation, and a peak of the pore size distribution can be measured by measurement methods described below.

### [Volume-Average Diameter and Coefficient of Variation]

The volume-average diameter can be measured with a particle size distribution meter (for example, “Zeta-potential and Particle size measurement system ELSZ-2” manufactured by Otsuka Electronics Co., Ltd.) using a laser Doppler method. The coefficient of variation can be determined according to the formula (1) above from the volume-average diameter and standard deviation measured with the same apparatus.

### [Peak of Pore Distribution]

A peak of a pore size distribution can be measured with a pore size distribution analyzer (for example, “ASAP2020” manufactured by Shimadzu Corporation) and determined by a peak value of the measured pore size distribution.

The composition for an antireflection coating of the present invention contains the porous silica particles (E) and the binder resin (F). Since a mixed layer including the porous silica particles (E) and the binder resin (F) forms a low-refractive-index layer, the binder resin (F) preferably forms a coating film with a low refractive index, specifically, a refractive index of 1.30 to 1.60. Examples of the binder resin (F) include solvent-soluble resins such as polyvinyl acetate and copolymer resins thereof, ethylene-acetic acid copolymer resins, vinyl chloride-vinyl acetate copolymer resins, urethane resins, vinyl chloride resins, chlorinated polypropylene resins, polyamide resins, acrylic resins, maleic acid resins, cyclized rubber resins, polyolefin resins, polystyrene resins, ABS resins, polyester resins, nylon resins, polycarbonate resins, cellulose resins, polylactic acid resins, and the like; thermosetting resins such as phenol resins, unsaturated polyester resins, epoxy resins, and the like; active-energy-ray-curable resins; and the like. Among these, the active-energy-ray-curable resins are preferred because coating films can be formed at relatively low temperatures within a short time, thereby increasing productivity.

The active-energy-ray-curable resins include an active-energy-ray-curable resin (b1) described below and an active-energy-ray-curable monomer (b2), and these may be used alone or in combination.

Examples of the active-energy-ray-curable resin (b1) include urethane (meth)acrylate resins, unsaturated polyester resins, epoxy(meth)acrylate resins, polyester (meth)acrylate resins, acryl (meth)acrylate resins, resins having maleimide groups, and the like.

The urethane (meth)acrylate resins include a resin having a urethane bond and a (meth)acryloyl group and produced by reaction between an aliphatic polyisocyanate compound or aromatic polyisocyanate compound and a (meth)acrylate compound having a hydroxyl group.

Examples of the aliphatic polyisocyanate compound include tetramethylene diisocyanate, pentamethylene diisocyanate, hexamethylene diisocyanate, heptamethylene diisocyanate, octamethylene diisocyanate, decamethylene diisocyanate, 2-methyl-1,5-pentane diisocyanate, 3-methyl-1,5-pentane diisocyanate, dodecamethylene diisocyanate, 2-methylpentamethylene diisocyanate, 2,2,4-trimethylhexamethylene diisocyanate, 2,4,4-trimethylhexamethylene diisocyanate, isophorone diisocyanate, norbornane diisocyanate, hydrogenated diphenylmethane diisocyanate, hydrogenated tolylene diisocyanate, hydrogenated xylylene diisocyanate, hydrogenated tetramethylxylylene diisocyanate, cyclohexyl diisocyanate, and the like. Examples of the aromatic polyisocyanate compound include tolylene diisocyanate, 4,4′-diphenylmethane diisocyanate, xylylene diisocyanate, 1,5-naphthalene diisocyanate, tolidine diisocyanate, p-phenylene diisocyanate, and the like.

Examples of the hydroxyl group-containing acrylate compound include 2-hydroxyethyl (meth)acrylate, 2-hydroxypropyl (meth)acrylate, 2-hydroxybutyl (meth)acrylate, 4-hydroxybutyl (meth)acrylate, dihydric alcohol mono(meth)acrylates such as 1,5-pentanediol mono(meth)acrylate, 1,6-hexanediol mono(meth)acrylate, neopentylglycol mono(meth)acrylate, neopentylglycol hydroxypivalate mono(meth)acrylate, and the like; trihydric alcohol mono- or di(meth)acrylates such as trimethylolpropane di(meth)acrylate, ethoxylated trimethylolpropane (meth)acrylate, propoxylated trimethylolpropane di(meth)acrylate, glycerin di(meth)acrylate, bis(2-(meth)acryloyloxyethyl)hydroxyethyl isocyanurate, and the like, and hydroxyl group-containing mono- or di(meth)acrylates produced by partially modifying alcoholic hydroxyl groups of the trihydric alcohol mono- or di(meth)acrylates with γ-caprolactone; compounds each containing a monofunctional hydroxyl group and tri- or higher-functional (meth)acryloyl group, such as pentaerythritol tri(meth)acrylate, ditrimethylolpropane tri(meth)acrylate, dipentaerythritol penta(meth)acrylate, and the like, and hydroxyl group-containing polyfunctional (meth)acrylates produced by modifying these compounds with γ-caprolactone; (meth)acrylate compounds each containing an oxyalkylene chain, such as dipropylene glycol mono(meth)acrylate, diethylene glycol mono(meth)acrylate, polypropylene glycol mono(meth)acrylate, polyethylene glycol mono(meth)acrylate, and the like; (meth)acrylate compounds each containing a block-structure oxyalkylene chain, such as polyethylene glycol-polypropylene glycol mono(meth)acrylate, polyoxybutylene-polyoxypropylene mono(meth)acrylate, and the like; (meth)acrylate compounds each containing a random-structure oxyalkylene chain, such as poly(ethylene glycol-tetramethylene glycol) mono(meth)acrylate, poly(propylene glycol-tetramethylene glycol) mono(meth)acrylate, and the like.

The reaction between the aliphatic polyisocyanate compound or aromatic polyisocyanate compound and the hydroxyl group-containing (meth)acrylate compound can be performed in the presence of a urethanization catalyst according to a usual method. Specific examples of the urethanization catalyst used include amines such as pyridine, pyrrole, triethylamine, diethylamine, dibutylamine, and the like; phosphines such as triphenylphosphine, triethylphosphine, and the like; organic tin compounds such as dibutyltin dilaurate, octyltin trilaurate, octyltin diacetate, dibutyltin diacetate, tin octylate, and the like; and organic metal compounds such as zinc octylate, and the like.

Among these urethane (meth)acrylate resins, those produced by reaction between the aliphatic polyisocyanate compound and the hydroxyl group-containing (meth)acrylate compound are particularly preferred because of excellent transparency of cured coating films, good sensitivity to active energy rays, and excellent curability. In addition, polyfunctional (meth)acrylates each containing a plurality of (meth)acryloyl groups are preferred as the hydroxyl group-containing (meth)acrylate compound because of excellent hardness of cured coating films.

Next, the unsaturated polyester resins are curable resins produced by plycondensation of an α,β-unsaturated dibasic acid or anhydride thereof, an aromatic saturated dibasic acid or anhydride thereof, and glycol. Examples of the α,β-unsaturated dibasic acid or anhydride thereof include maleic acid, maleic anhydride, fumaric acid, itaconic acid, citraconic acid, chloromaleic acid, and esters thereof. Examples of the aromatic saturated dibasic acid or anhydride thereof include phthalic acid, phthalic anhydride, isophthalic acid, terephthalic acid, nitrophthalic acid, tetrahydrophthalic anhydride, endo-methylenetetrahydrophthalic anhydride, halogenated phthalic anhydride, and esters thereof. Examples of the aliphatic or alicyclic saturated dibasic acid include oxalic acid, malonic acid, succinic acid, adipic acid, sebacic acid, azelaic acid, glutaric acid, hexahydrophthalic anhydride, and esters thereof. Examples of the glycol include ethylene glycol, propylene glycol, diethylene glycol, dipropylene glycol, 1,3-butanediol, 1,4-butanediol, 2-methylpropane-1,3-diol, neopentyl glycol, triethylene glycol, tetraethylene glycol, 1,5-pentanediol, 1,6-hexanediol, bisphenol A, hydrogenated bisphenol A, ethylene glycol carbonate, 2,2-di-(4-hydroxypropoxydiphenyl)propane, and the like. Besides these, oxides such as ethylene oxide, propylene oxide, and the like can also be used.

Next, the epoxyvinyl ester resins can be produced by reaction of (meth)acrylic acid with an epoxy group of an epoxy resin such as bisphenol A epoxy resin, bisphenol F epoxy resin, phenol novolac epoxy resin, cresol novolac epoxy resin, or the like.

Examples of the maleimide group-containing resins include a bifunctional maleimideurethane compound produced by urethanizing N-hydroxyethyl maleimide and isophorone diisocyanate, a bifunctional maleimide ester compound produced by esterifying maleimidoacetic acid and polytetramethylene glycol, a tetrafunctional maleimide ester compound produced by esterifying maleimidocaproic acid and a tetraethylene oxide adduct of pentaerythritol, a polyfunctional maleimide ester compound produced by esterifying maleimidoacetic acid and a polyhydric alcohol compound, and the like. These active-energy-ray-curable resins (b1) can be used alone or in combination of two or more.

Examples of the active-energy-ray-curable monomer (b2) include ethylene glycol di(meth)acrylate, diethylene glycol di(meth)acrylate, triethylene glycol di(meth)acrylate, polyethylene glycol di(meth)acrylate having a number-average molecular weight in a range of 150 to 1000, propylene glycol di(meth)acrylate, dipropylene glycol di(meth)acrylate, tripropylene glycol di(meth)acrylate, polypropylene glycol di(meth)acrylate having a number-average molecular weight in a range of 150 to 1000, neopentyl glycol di(meth)acrylate, 1,3-buthanediol di(meth)acrylate, 1,4-butanediol di(meth)acrylate, 1,6-hexanediol di(meth)acrylate, neopentyl glycol hydroxypivalic acid ester di(meth)acrylate, bisphenol A di(meth)acrylate, trimethylolpropane tri(meth)acrylate, pentaerythritol tri(meth)acrylate, dipentaerythritol hexa(meth)acrylate, pentaerythritol tetra(meth)acrylate, trimethylolpropane di(meth)acrylate, dipentaerythritol penta(meth)acrylate, dicyclopentenyl (meth)acrylate, aliphatic alkyl (meth)acrylates such as methyl (meth)acrylate, propyl (meth)acrylate, butyl (meth)acrylate, tert-butyl (meth)acrylate, 2-ethylhexyl (meth)acrylate, octyl (meth)acrylate, decyl (meth)acrylate, isodecyl (meth)acrylate, lauryl (meth)acrylate, stearyl (meth)acrylate, isostearyl (meth)acrylate, and the like, glycerol (meth)acrylate, 2-hydroxyethyl (meth)acrylate, 3-chloro-2-hydroxypropyl (meth)acrylate, glycidyl (meth)acrylate, allyl (meth)acrylate, 2-butoxyethyl (meth)acrylate, 2-(diethylamino)ethyl (meth)acrylate, 2-(dimethylamino)ethyl (meth)acrylate, γ-(meth)acryloxypropyl trimethoxysilane, 2-methoxyethyl (meth)acrylate, methoxydiethylene glycol (meth)acrylate, methoxydipropylene glycol (meth)acrylate, nonylphenoxypolyethylene glycol (meth)acrylate, nonylphenoxypolypropylene glycol (meth)acrylate, phenoxyethyl (meth)acrylate, phenoxydipropylene glycol (meth)acrylate, phenoxypolypropylene glycol (meth)acrylate, polybutadiene (meth)acrylate, polyethylene glycol-polypropylene glycol (meth)acrylate, polyethylene glycol-polybutylene glycol (meth)acrylate, polystyrylethyl (meth)acrylate, benzyl (meth)acrylate, cyclohexyl (meth) acrylate, dicyclopentanyl (meth)acrylate, dicyclopentenyl (meth)acrylate, isobornyl (meth)acrylate, methoxylated cyclodecatriene (meth)acrylate, phenyl (meth)acrylate, and maleimides such as maleimide, N-methylmaleimide, N-ethylmaleimide, N-propylmaleimide, N-butylmaleimide, N-hexylmaleimide, N-octylmaleimide, N-dodecylmaleimide, N-stearylmaleimide, N-phenylmaleimide, N-cyclohexylmaleimide, 2-maleimidoethyl-ethyl carbonate, 2-maleimidoethyl-propyl carbonate, N-ethyl-(2-maleimidoethyl) carbamate, N,N-hexamethylenebismaleimide, polypropylene glycol-bis(3-maleimidopropyl)ether, bis(2-maleimidoethyl) carbonate, 1,4-dimaleimidocyclohexane, and the like.

Among these, tri- or higher-functional (meth)acrylates such as trimethylolpropane tri(meth)acrylate, pentaerythritol tri(meth)acrylate, dipentaerythritol hexa(meth)acrylate, pentaerythritol tetra(meth)acrylate, and the like are particularly preferred because of excellent hardness of cured coatings. These active-energy-ray-curable monomers can be used alone or in combination of two or more.

The amount of the porous silica particles (E) mixed with the binder resin (F) used in the present invention may be such an amount that a monolayer of the porous silica particles can be formed on a surface of a coating film of the composition for an antireflection coating of the present invention, and is preferably adjusted according to the amount of coating of the substrate with the composition for an antireflection coating of the present invention. For example, when 4.75 parts by mass of the porous silica particles (E) is added to 100 parts by mass of the binder resin (F), this amount corresponds to such an amount that a monolayer of the porous silica particles (E) can be formed in 100 nm on a surface of a hard coat having a thickness of 5 μm.

The substrate of an article on a surface of which the antireflection coating can be formed using the composition for an antireflection coating of the present invention can be composed of a material such as a metal, glass, plastic, or the like, and has a surface shape such as a shape having a smooth surface on which an image is reflected. The article of the present invention includes the antireflection coating formed by coating at least one of the surfaces of the substrate with the composition for an antireflection coating.

An antireflection film of the present invention includes an antireflection coating formed by coating at least one of the surfaces of a film used as the substrate with the composition for an antireflection coating. A production method using the composition for an antireflection coating containing an active-energy-ray-curable resin as the binder resin (F) is described. After the base film is coated with the composition for an antireflection coating, active energy rays are applied for forming the antireflection coating as a coating film by curing the resin for an antireflection coating. Examples of the active energy rays include ultraviolet light, ionizing radiations such as electron beams, α-rays, β-rays, γ-rays, and the like. When the cured coating film is formed by irradiation with ultraviolet light as the active-energy rays, a photopolymerization initiator is preferably added to the active-energy-ray-curable composition to improve curability. If required, a photosensitizer can be further added to improve curability. On the other hand, ionizing radiation such as electron beams, α-rays, β-rays, γ-rays, or the like is used, the photopolymerization initiator and the photosensitizer particularly need not be added because curing rapidly proceeds without using the photopolymerization initiator and the photosensitizer.

The photopolymerization initiator may be an intramolecular cleavage-type photopolymerization initiator or a hydrogen abstraction-type photopolymerization initiator. Examples of the intramolecular cleavage-type photopolymerization initiator include acetophenone compounds such as diethoxyacetophenone, 2-hydroxy-2-methyl-1-phenylpropan-1-one, benzyldimethyl ketal, 1-(4-isopropylphenyl)-2-hydroxy-2-methylpropan-1-one, 4-(2-hydroxyethoxy)phenyl-(2-hydroxy-2-propyl)ketone, 1-hydroxycyclohexyl-phenyl ketone, 2-methyl-2-morpholino(4-thiomethylphenyl)propan-1-one, 2-benzyl-2-dimethylamino-1-(4-morpholinophenyl)-butanone, 2-[2-oxo-2-phenylacetoxyethoxy]ethyl ester, 2-(2-hydroxyethoxy)ethyl ester, and the like; benzoins such as benzoin, benzoin methyl ether, benzoin isopropyl ether, and the like; acylphosphine oxide compounds such as 2,4,6-trimethylbenzoin diphenylphosphine oxide, bis(2,4,6-trimethylbenzoyl)-phenylphosphine oxide, and the like; benzyl; methylphenol glyoxyester; and the like.

On the other hand, examples of the hydrogen abstraction-type photopolymerization initiator include benzophenone compounds such as benzophenone, methyl o-benzoylbenzoate-4-phenylbenzophenone, 4,4′-dichlorobenzophenone, hydroxybenzophenone, 4-benzoyl-4′-methyl-diphenyl sulfide, acrylated benzophenone, 3,3′,4,4′-tetra(tert-butylperoxycarbonyl)benzophenone, 3,3′-dimethyl-4-methoxybenzophenone, and the like; thioxanthone compounds such as 2-isopropylthioxanthone, 2,4-dimethylthioxanthone, 2,4-diethylthioxanthone, 2,4-dichlorothioxanthone, and the like; aminobenzophenone compounds such as Michler's ketone, 4,4′-diethylaminobenzophenone, and the like; 10-butyl-2-chloroacridone; 2-ethylanthraquinone; 9,10-phenanthrenequinone; camphor quinone; and the like.

Examples of the photosensitizer include amines such as aliphatic amines, aromatic amines, and the like; ureas such, as o-tolylthiourea and the like; and sulfur compounds such as sodium diethyl dithiophosphate, S-benzylisothiuronium-p-toluene sulfonate, and the like.

The amount of each of the photopolymerization initiator and the photosensitizer used is preferably 0.01 to 20 parts by mass, more preferably 0.1 to 15% by mass, still more preferably 0.3 to 7 parts by mass, relative to 100 parts by mass of nonvolatile components in the composition for an antireflection coating.

For the purpose of adjusting viscosity and refractive index, adjusting color tone, or adjusting other coating material properties and coating physical properties, various compounding materials may be further added to the composition for an antireflection coating of the present invention according to purposes such as application, characteristics, or the like within a range in which the effect of the present invention is not impaired. Examples of the compounding materials include various organic solvents; various resins such as acryl resins, phenol resins, polyester resins, polystyrene resins, urethane resins, urea resins, melamine resins, alkyd resins, epoxy resins, polyamide resins, polycarbonate resins, petroleum resins, fluorocarbon resins, and the like; various organic or inorganic particles of PTFE (polytetrafluoroethylene), polyethylene, polypropylene, carbon, titanium oxide, alumina, copper, silica fine particles, and the like; a polymerization initiator, a polymerization inhibitor, an antistatic agent, a defoaming agent, a viscosity modifier, a light stabilizer, a weather stabilizer, a heat stabilizer, an antioxidant, an anticorrosive agent, a slipping agent, wax, a luster adjuster, a mold release agent, a compatibilizer, a conduction adjuster, a pigment, a dye, a dispersant, a dispersion stabilizer, a silicone-based or hydrocarbon-based surfactant, and the like.

Among the compounding materials, the organic solvent is advantageous for appropriately adjusting the solution viscosity of the composition for an antireflection coating of the present invention, and particularly, the thickness can be easily adjusted for thin-film coating. Examples of the organic solvent which can be used include aromatic hydrocarbons such as toluene, xylene, and the like; alcohols such as methanol, ethanol, isopropanol, tert-butanol, and the like; esters such as ethyl acetate, propylene glycol monomethyl ether acetate, and the like; and ketones such as methyl ethyl ketone, methyl isobutyl ketone, cyclohexanone, and the like. These solvents can be used alone or in combination of two or more.

The amount of the organic solvent used is, on a mass basis, preferably in a range of 0.5 to 4 times the total mass of curing components, depending on the use and the intended thickness and viscosity.

As described above, ultraviolet light or ionizing radiation such as electron beams, α-rays, β-rays, γ-rays, or the like can be used as active energy rays for curing the composition for an antireflection coating of the present invention. Specific examples of an energy source or curing apparatus include a sterilization lamp, a fluorescent lamp for ultraviolet light, a carbon arc, a xenon lamp, a high-pressure mercury lamp for reproduction, a medium-pressure or high-pressure mercury lamp, a ultrahigh-pressure mercury lamp, an electrodeless lamp, a metal halide lamp, ultraviolet light from a light source such as natural light, electron beams from a scanning- or curtain-type electron beam accelerator, and the like. In view of simplicity of an apparatus, an apparatus which emits ultraviolet light is preferably used.

The base film used for the antireflection film of the present invention may have a film form or a sheet form and preferably has a thickness in a range of 20 to 500 μm. A material of the base film is preferably a resin having high transparency, and examples thereof the resin include polyester resins such as polyethylene terephthalate, polybutylene terephthalate, polyethylene naphthalate, and the like; polyolefin resins such as polypropylene, polyethylene, polymethylpentene-1, and the like; cellulose resins such as cellulose acetate (diacetyl cellulose, triacetyl cellulose, and the like), cellulose acetate propionate, cellulose acetate butylate, cellulose acetate propionate butylate, cellulose acetate phthalate, cellulose nitrate, and the like; acryl resins such as polymethyl methacrylate, and the like; vinyl chloride resins such as polyvinyl chloride, polyvinylidene chloride, and the like; polyvinyl alcohol; ethylene-vinyl acetate copolymer; polystyrene; polyamide; polycarbonate; polysulfone; polyethersulfone; polyether-ether ketone; polyimide resins such as polyimide, polyetherimide, and the like; norbornene resins (for example, “Zeonor” manufactured by Zeon Corporation), modified norbornene resins (for example, “Arton” manufactured by JSR Co., Ltd.), cyclic olefin copolymers (for example, “Apel” manufactured by Mitsui Chemicals Inc.), and the like. Further, two or more substrates of these resins may be bonded together.

Examples of a method for coating the substrate with the composition for an antireflection coating of the present invention include coating methods using a gravure coater, a roll coater, a comma coater, a knife coater, an air knife coater, a curtain coater, a kiss coater, a shower coater, a wheeler coater, a spin coater, dipping, screen printing, a spray, an applicator, a bar coater, and the like. Even when among these, a coating apparatus which applies pressure, such as a gravure coater, a roll coater, or the like is used, the porous silica particles (A) used in the present invention are not broken, and thus the antireflection film having a stable antireflection property can be formed without deterioration in the antireflection property due to coating.

When the composition for an antireflection coating of the present invention contains an organic solvent, the organic solvent is preferably evaporated after the base film is coated with the composition for an antireflection coating and before irradiated with the active energy rays, and the coating film is preferably dried by heating or at room temperature in order to segregate the porous silica (F) on the surface of the coating film. A condition for heat drying is not particularly limited as long as the organic solvent is evaporated but, in general, heat drying is preferably performed at a temperature in a range of 50° C. to 100° C. for a time in a range of 1 to 10 minutes.

The antireflection film of the present invention can be formed by the above-described operations.

### EXAMPLES

The present invention is described in further detail below by way of examples and comparative examples. The physical property values of synthesized porous silica particles were measured by methods described below.

### [Particle Shape]

The particle shape was confirmed by observation at 50,000× with a field-emission-type scanning electron microscope (FE-SEM) (for example, “JSM6700” manufactured by JEOL, Ltd.).

### [Average Particle Diameter]

The particle diameters of particles in the same field of view were measured by observation at 50,000× with a field-emission-type scanning electron microscope (FE-SEM) (for example, “JSM6700” manufactured by JEOL, Ltd.), and the measured values were averaged to determine an average particle diameter.

### [Average Pore Diameter]

The average pore diameter was measured with a pore size distribution analyzer (for example, “ASAP2020” manufactured by Shimadzu Corporation).

### [Specific Surface Area]

The specific surface area was measured by a BET method using a pore size distribution analyzer (for example, “ASAP2020” manufactured by Shimadzu Corporation).

### [Volume-Average Diameter and Coefficient of Variation]

The volume-average diameter was measured with a particle size distribution meter (“Zeta-potential and Particle size measurement system ELSZ-2” manufactured by Otsuka Electronics Co., Ltd.) using a laser Doppler method. The coefficient of variation was determined according to formula (1) below from the volume-average diameter and standard deviation measured with the same apparatus. The standard deviation in the formula (1) below was calculated according to formula (2) below. In the formula (2) below, d84% represents a diameter at a point of 84% in a volume-particle size distribution, and d16% represents a diameter at a point of 16% in a volume-particle size distribution.

[Math. 2]

Coefficient of variation (%)=standard deviation (nm)/volume-average diameter (nm)×100 (1)

Standard deviation (nm)=(d84% (nm)−d16% (nm))/2 (2)

### [Peak of Pore Size Distribution]

A peak of a pore size distribution was measured with a pore size distribution analyzer (for example, “ASAP2020” manufactured by Shimadzu Corporation) and was determined by a peak value of the measured pore size distribution.

### Example 1

In a 500 mL four-neck flask provided with a thermometer and a stirring blade, 213.2 g of methanol, 61.3 g of pure water, and 27.4 g of, 28 mass % ammonia water were placed and uniformly mixed by stirring (solution B), and the inner temperature was kept at 20° C. In another vessel, 34.3 g of tetramethoxysilane (abbreviated as “TMOS” hereinafter), 45.1 g of methanol, and 6.5 g of octylamine were uniformly mixed (solution A). The solution A was poured into the solution B over 120 minutes under stirring while the inside of the flask was kept at 20° C. After pouring of the solution A was completed, reaction was continued at 20° C. for 60 minutes. After the completion of reaction, the reaction solution was centrifuged at 10,000 rpm for 10 minutes, and then a supernatant was discarded to obtain precipitates.

Then, 200 g of methanol was added to the resultant precipitates and stirred and mixed to prepare a suspension. The suspension was centrifuged at 10,000 rpm for 10 minutes, and a supernatant was discarded to obtain precipitates which were then washed with methanol. Methanol washing was further repeated two times. The resultant precipitates were dried at 120° C. for 6 hours to produce a white powder. The resultant white powder was placed in an electric furnace, heated from 25° C. to 600° C. at a heating rate of 2° C./min in an air atmosphere, and fired at 600° C. for 3 hours. The fired powder was cooled and then ground with a mortar to produce 12.5 g of porous silica white particles. Observation of the resultant porous silica particles with a field emission-type scanning electron microscope (FE-SEM) showed a spherical particle shape. In addition, the porous silica particles had an average particle diameter of 101 nm, an average pore diameter of 1.5 nm, and a BET-method specific surface area of 43 m²/g. FIG. 1 shows a photograph obtained by observing the porous silica particles with a field emission-type scanning electron microscope (FE-SEM) at 50,000×.

### Example 2

In a 500 mL four-neck flask provided with a thermometer and a stirring blade, 213.2 g of methanol, 61.3 g of pure water, and 27.4 g of 28 mass % ammonia water were placed and uniformly mixed by stirring (solution B), and the inner temperature was kept at 20° C. In another vessel, 34.3 g of TMOS, 45.1 g of methanol, and 39.3 g of decylamine were uniformly mixed (solution A). The solution A was poured into the solution B over 120 minutes under stirring while the inside of the flask was kept at 20° C. After pouring of the solution A was completed, reaction was continued at 20° C. for 60 minutes. After the completion of reaction, the reaction solution was centrifuged at 10,000 rpm for 10 minutes, and then a supernatant was discarded to obtain precipitates.

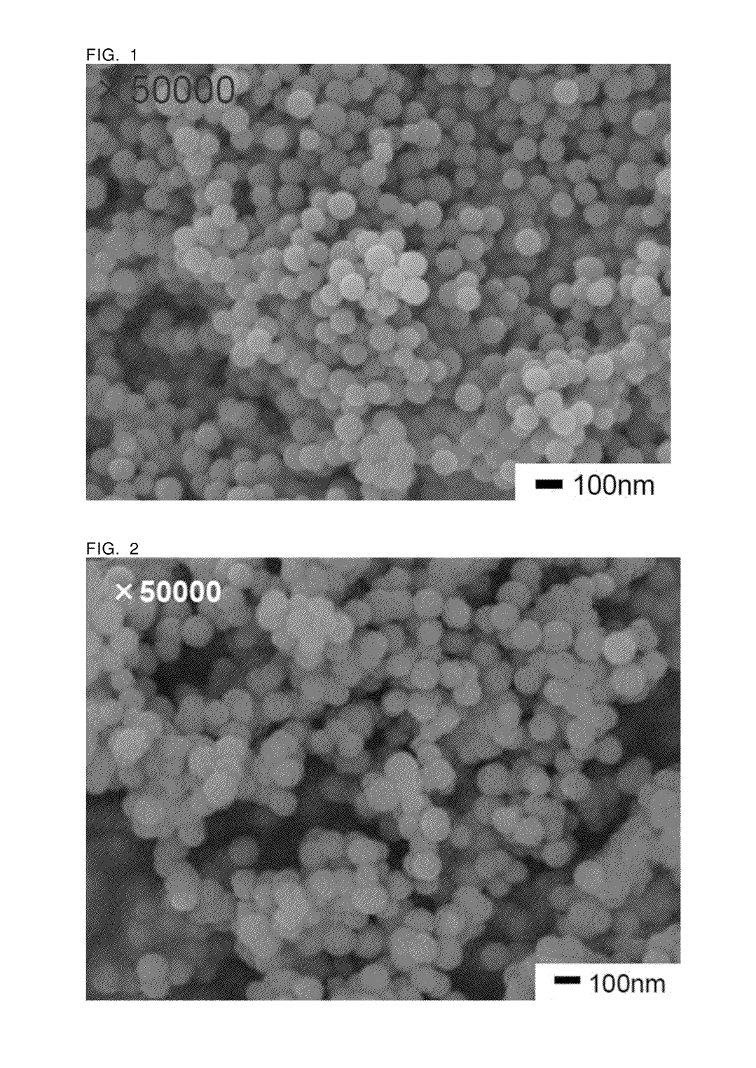

Then, 200 g of methanol was added to the resultant precipitates and stirred and mixed to prepare a suspension. The suspension was centrifuged at 10,000 rpm for 10 minutes, and a supernatant was discarded to obtain precipitates which were then washed with methanol. Methanol washing was further repeated two times. The resultant precipitates were dried at 120° C. for 6 hours to produce a white powder. The resultant white powder was placed in an electric furnace, heated from 25° C. to 600° C. at a heating rate of 2° C./min in an air atmosphere, and fired at 600° C. for 3 hours. The fired powder was cooled and then ground with a mortar to produce 12.1 g of porous silica white particles. Observation of the resultant porous silica particles with a field emission-type scanning electron microscope (FE-SEM) showed a spherical particle shape. In addition, the porous silica particles had an average particle diameter of 139 nm, an average pore diameter of 1.8 nm, and a BET-method specific surface area of 757 m²/g. FIG. 2 shows a photograph obtained by observing the porous silica particles with a field emission-type scanning electron microscope (FE-SEM) at 50,000×.

### Example 3

In a 500 mL four-neck flask provided with a thermometer and a stirring blade, 213.2 g of methanol, 61.3 g of pure water, and 27.4 g of 28 mass % ammonia water were placed and uniformly mixed by stirring (solution B), and the inner temperature was kept at 20° C. In another vessel, 34.3 g of TMOS, 45.1 g of methanol, and 9.3 g of laurylamine were uniformly mixed (solution A). The solution A was poured into the solution B over 120 minutes while the inside of the flask was kept at 20° C. After pouring of the solution A was completed, reaction was continued at 20° C. for 60 minutes. After the completion of reaction, the reaction solution was centrifuged at 10,000 rpm for 10 minutes, and then a supernatant was discarded to obtain precipitates.

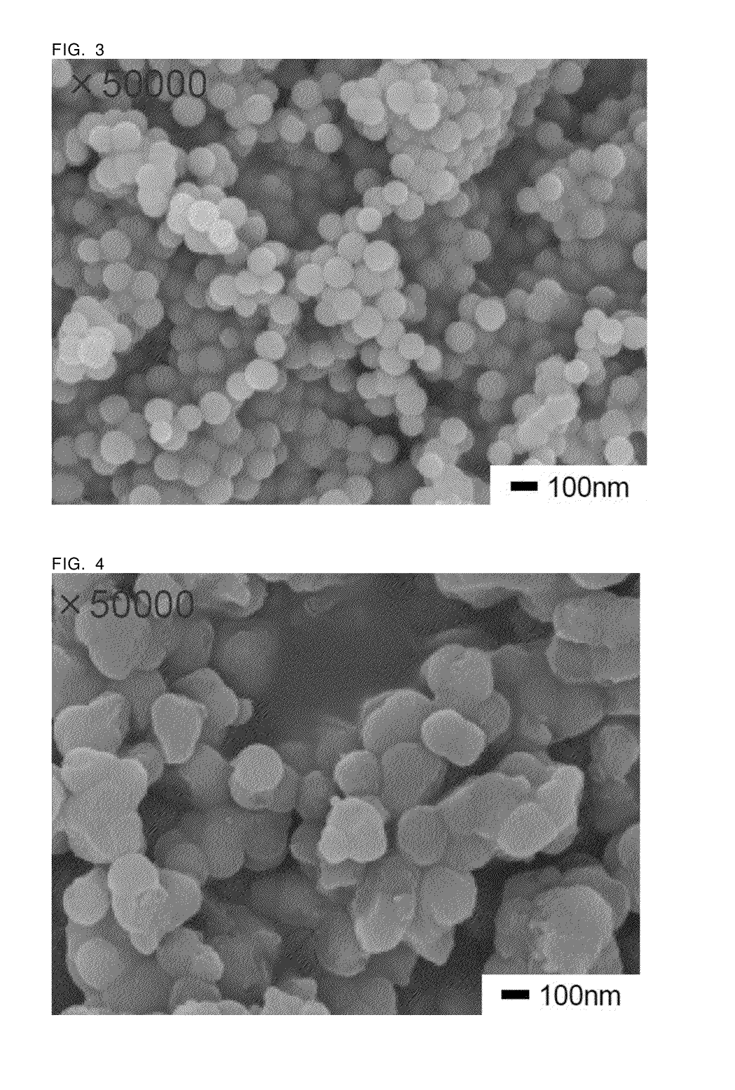

Then, 200 g of methanol was added to the resultant precipitates and mixed to prepare a suspension. The suspension was centrifuged at 10,000 rpm for 10 minutes, and a supernatant was discarded to obtain precipitates which were then washed with methanol. Methanol washing was further repeated two times. The resultant precipitates were dried at 120° C. for 6 hours to produce a white powder. The resultant white powder was placed in an electric furnace, heated from 25° C. to 600° C. at a heating rate of 2° C./min in an air atmosphere, and fired at 600° C. for 3 hours. The fired powder was cooled and then ground with a mortar to produce 12.0 g of porous silica white particles. Observation of the resultant porous silica particles with a field emission-type scanning electron microscope (FE-SEM) showed a spherical particle shape. In addition, the porous silica particles had an average particle diameter of 122 nm, an average pore diameter of 1.8 nm, and a BET-method specific surface area of 216 m²/g. FIG. 3 shows a photograph obtained by observing the porous silica particles with a field emission-type scanning electron microscope (FE-SEM) at 50,000×.

### Example 4

In a 500 mL four-neck flask provided with a thermometer and a stirring blade, 213.2 g of methanol, 61.3 g of pure water, and 27.4 g of 28 mass % ammonia water were placed and uniformly mixed by stirring (solution B), and the inner temperature was kept at 20° C. In another vessel, 34.3 g of TMOS, 45.1 g of methanol, and 13.4 g of oleylamine were uniformly mixed (solution A). The solution A was poured into the solution B over 120 minutes under stirring while the inside of the flask was kept at 20° C. After pouring of the solution A was completed, reaction was continued at 20° C. for 60 minutes. After the completion of reaction, the reaction solution was centrifuged at 10,000 rpm for 10 minutes, and then a supernatant was discarded to obtain precipitates.

Then, 200 g of methanol was added to the resultant precipitates and stirred and mixed to prepare a suspension. The suspension was centrifuged at 10,000 rpm for 10 minutes, and a supernatant was discarded to obtain precipitates which were then washed with methanol. Methanol washing was further repeated two times. The resultant precipitates were dried at 120° C. for 6 hours to produce a white powder. The resultant white powder was placed in an electric furnace, heated from 25° C. to 600° C. at a heating rate of 2° C./min in an air atmosphere, and fired at 600° C. for 3 hours. The fired powder was cooled and then ground with a mortar to produce 12.6 g of porous silica white particles. Observation of the resultant porous silica particles with a field emission-type scanning electron microscope (FE-SEM) showed a nearly spherical particle shape. In addition, the porous silica particles had an average particle diameter of 171 nm, an average pore diameter of 2.2 nm, and a BET-method specific surface area of 583 m²/g. FIG. 4 shows a photograph obtained by observing the porous silica particles with a field emission-type scanning electron microscope (FE-SEM) at 50,000×.

### Example 5

In a 500 mL four-neck flask provided with a thermometer and a stirring blade, 213.2 g of ethanol, 77.9 g of pure water, and 4.4 g of 28 mass % ammonia water were placed and uniformly mixed by stirring (solution B), and the inner temperature was kept at 27° C. In another vessel, 28.6 g of tetraethoxysilane (abbreviated as “TEOS” hereinafter), 45.0 g of ethanol, and 13.4 g of laurylamine were uniformly mixed (solution A). The solution A was poured into the solution B at once under stirring while the inside of the flask was kept at 27° C. After pouring of the solution A was completed, reaction was continued at 27° C. for 5 hours. Then, the inside of the flask was heated to 65° C., and reaction was further continued for 9 hours. After the completion of reaction, the reaction solution was centrifuged at 10,000 rpm for 10 minutes, and then a supernatant was discarded to obtain precipitates.

Then, 200 g of methanol was added to the resultant precipitates and stirred and mixed to prepare a suspension. The suspension was centrifuged at 10,000 rpm for 10 minutes, and a supernatant was discarded to obtain precipitates which were then washed with methanol. Methanol washing was further repeated two times. The resultant precipitates were dried at 120° C. for 6 hours to produce a white powder. The resultant white powder was placed in an electric furnace, heated from 25° C. to 600° C. at a heating rate of 2° C./min in an air atmosphere, and fired at 600° C. for 3 hours. The fired powder was cooled and then ground with a mortar to produce 12.0 g of porous silica white particles. Observation of the resultant porous silica particles with a field emission-type scanning electron microscope (FE-SEM) showed a spherical particle shape. In addition, the porous silica particles had an average particle diameter of 118 nm, an average pore diameter of 1.8 nm, and a BET-method specific surface area of 235 m²/g.

### Comparative Example 1

In a 500 mL four-neck flask provided with a thermometer and a stirring blade, 213.2 g of methanol, 61.3 g of pure water, and 27.4 g of 28 mass % ammonia water were placed and uniformly mixed by stirring (solution B), and the inner temperature was kept at 20° C. In another vessel, 34.3 g of TMOS and 45.1 g of methanol were uniformly mixed (solution A). The solution A was poured into the solution B under stirring over 120 minutes while the inside of the flask was kept at 20° C. After pouring was completed, reaction was continued at 20° C. for 60 minutes. After the completion of reaction, the reaction solution was centrifuged at 10,000 rpm for 10 minutes, and then a supernatant was discarded to obtain precipitates.

Then, 200 g of methanol was added to the resultant precipitates and stirred and mixed to prepare a suspension. The suspension was centrifuged at 10,000 rpm for 10 minutes, and a supernatant was discarded to obtain precipitates which were then washed with methanol. Methanol washing was further repeated two times. The resultant precipitates were dried at 120° C. for 6 hours to produce a white powder. The resultant white powder was placed in an electric furnace, heated from 25° C. to 600° C. at a heating rate of 2° C./min in an air atmosphere, and fired at 600° C. for 3 hours. The fired powder was cooled and then ground with a mortar to produce 13.3 g of silica white particles. Observation of the resultant porous silica particles with a field emission-type scanning electron microscope (FE-SEM) showed a spherical particle shape. In addition, the silica particles had an average particle diameter of 112 nm and a BET-method specific surface area of 29 m²/g. Pores could not be confirmed on the surfaces of the silica particles.

### Comparative Example 2

In a 500 mL four-neck flask provided with a thermometer and a stirring blade, 83.2 g of ethanol, 106 g of pure water, and 0.527 g of laurylamine were placed and uniformly mixed by stirring, and the inner temperature was kept at 25° C. In the flask, 5.2 g of TEOS was poured at once under stirring while the inside of the flask was kept at 25° C. After pouring was completed, reaction was continued at 25° C. for 3 hours, stirring was stopped, and then the reaction solution was allowed to stand for 18 hours. Then, the reaction solution was centrifuged at 10,000 rpm for 10 minutes, and then a supernatant was discarded to obtain precipitates.

Then, 200 g of ethanol was added to the resultant precipitates and stirred and mixed to prepare a suspension. The suspension was centrifuged at 10,000 rpm for 15 minutes, and a supernatant was discarded to obtain precipitates which were then washed with ethanol. Ethanol washing was further repeated 4 times. The resultant precipitates washed with ethanol were dried at 35° C. for 48 hours to produce a white powder. The resultant white powder was placed in an electric furnace, heated from 25° C. to 600° C. at a heating rate of 2° C./min in an air atmosphere, and fired at 600° C. for 3 hours. The fired powder was cooled and then ground with a mortar to produce 1.4 g of porous silica white particles. Observation of the resultant porous silica particles with a field emission-type scanning electron microscope (FE-SEM) showed a spherical particle shape. In addition, the porous silica particles had an average particle diameter of 1,230 nm, an average pore diameter of 3.6 nm, and a BET-method specific surface area of 589 m²/g.

### Comparative Example 3

In a 500 mL four-neck flask provided with a thermometer and a stirring blade, 138.7 g of ethanol, 106 g of pure water, and 1.3 g of laurylamine were placed and uniformly mixed by stirring, and the inner temperature was kept at 25° C. In the flask, 5.24 g of TEOS was poured at once under stirring while the inside of the flask was kept at 25° C. After pouring was completed, reaction was continued at 25° C. for 3 hours, stirring was stopped, and then the reaction solution was allowed to stand for 18 hours. Then, the reaction solution was centrifuged at 10,000 rpm for 10 minutes, and then a supernatant was discarded to obtain precipitates.

Then, 200 g of ethanol was added to the resultant precipitates and stirred and mixed to prepare a suspension. The suspension was centrifuged at 10,000 rpm for 15 minutes, and a supernatant was discarded to obtain precipitates which were then washed with ethanol. Ethanol washing was further repeated 4 times. The resultant precipitates washed with ethanol were dried at 35° C. for 48 hours to produce a white powder. The resultant white powder was placed in an electric furnace, heated from 25° C. to 600° C. at a heating rate of 2° C./min in an air atmosphere, and fired at 600° C. for 3 hours. The fired powder was cooled and then ground with a mortar to produce 1.4 g of porous silica white particles. Observation of the resultant porous silica particles with a field emission-type scanning electron microscope (FE-SEM) showed a spherical particle shape. In addition, the porous silica particles had an average particle diameter of 405 nm, an average pore diameter of 3.6 nm, and a BET-method specific surface area of 668 m²/g.

### Comparative Example 4

The same operation as in Example 3 was performed except that ammonia water was not used. After the completion of reaction, the reaction solution was centrifuged at 10,000 rpm for 10 minutes, but a supernatant was not separated from precipitates. Next, further centrifugation was performed at 10,000 rpm for 30 minutes, but a supernatant was not separated from precipitates. The reaction solution was allowed to stand at 25° C. for 24 hours, resulting in gelling.

### Comparative Example 5

In a vessel with an inner volume of 5 liters, 3290.4 g of pure water was placed and cooled to a temperature of about 0° C. (temperature near 0° C. without water freezing) under stirring at a rate of 50 rpm. Next, 375.0 g of vinyl trimethoxysilane (manufactured by Shin-Etsu Chemical Co., Ltd.) previously adjusted to a temperature of about 5° C. was slowly added to the pure water to prepare a two-layer separated solution including a vinyltrimethoxysilane layer (upper layer) and a water layer (lower layer). Further, the solution was cooled under stirring at a rate of 50 rpm until the temperature of the vinyltrimethoxysilane layer was about 1° C.

Also, in a vessel with an inner volume of 100 cc, 41.9 g of pure water was placed, and 1.05 g of n-butyl alcohol (manufactured by Kanto Chemical Co., Ltd.) and 0.4 g of 28 mass % ammonia water were added to the pure water under stirring at a rate of 100 rpm. Further, 3.75 g of sodium alkyldiphenyl ether disulfonate (manufactured by Kao Corporation) serving as an anionic surfactant was added to prepare a mixed solution. Further, the mixed solution was cooled under stirring at a rate of 100 rpm until the temperature of the mixed solution was about 5° C.

Next, the mixed solution was added to the water layer of the two-layer separated solution over 50 seconds under stirring at a rate of 50 rpm so that the organic silicon compound layer positioned in an upper portion and the water layer positioned in a lower portion of the two-layer separated solution were not completely mixed. The addition was performed by flowing out the mixed solution from a tip nozzle of a conduit inserted up to a lower portion of the water layer. Then, the water layer (aqueous mixed solution) to which the mixed solution had been added was maintained at a temperature of about 1° C. and continuously stirred at a rate of 50 rpm for about 4.5 hours until the organic silicon compound layer disappeared by proceeding of hydrolysis reaction of the organic silicon compound. In this case, the pH of the water layer (aqueous mixed solution) was about 8.8 on an average.

Further, the aqueous mixed solution without the organic silicon compound layer was allowed to stand at a temperature condition of about 15° C. for 3 hours while being gently stirred at a rate of 50 rpm. This yielded an aqueous mixed solution containing a silica-based particle precursor composed of a partial hydrolysate and/or hydrolysate of vinylmethoxysilane in the water layer (aqueous mixed solution).

Further, 42.7 g of an aqueous sodium aluminate solution (manufactured by Catalysts & Chemicals Industries Co., Ltd.) containing 22.12% by weight of sodium metaaluminate in terms of Al₂O₃ was added to 3712.5 g of the aqueous mixed solution over 60 seconds under stirring at a rate of 200 rpm. In addition, a ratio (Al₂O₃/SiO₂) of weight of sodium aluminate in terms of Al₂O₃ to the organic silicon compound (vinyltrimethoxysilane) in terms of SiO₂ was 5/95.

In this case, the aqueous sodium aluminate solution was added from above to the surface of the aqueous mixed solution. During addition, the aqueous mixed solution was kept at a temperature of about 18° C. Further, the aqueous mixed solution was allowed to stand under a temperature condition of about 18° C. for 15 hours while being gently stirred at a rate of 200 rpm. This yielded an aqueous mixed solution containing silica-based particles having internal pores or voids produced by elusion of part of the silica-based components contained in the silica-based particle precursor.

Then, 3643 g of the aqueous mixed solution obtained in the above-described step was subjected to a centrifugal separator (H-900 manufactured by Kokusan Co., Ltd.) to separate the silica-based particles. Further, the resultant cake-like substance was stirred while pure water was added, preparing a dispersion liquid. The centrifugal operation was repeated 3 times. The silica-based particles (cake-like substance) sufficiently washed were dried at 110° C. over 12 hours. As a result, 63 g of porous silica particles having internal pores or voids and having surfaces (circumference) coated with coating layers of the silica-based component were produced. The silica particles had an average particle diameter of 4.7 μm.

Table 1 shows the amount of the solvent (volume of the reaction solution) used for producing silica particles, the yield of silica particles, and yield (%) of silica particles per solvent amount (percentage of a value obtained by dividing the yield of silica particles by the solvent amount) in each of Examples 1 to 5 and Comparative Examples 1 to 3 (the solvent amount includes the amount of water in ammonia water). Table 1 also shows the characteristic values of the silica particles produced in each of Examples 1 to 5 and Comparative Examples 1 to 3.

TABLE 1

| | Example | Example | Example | Example | Example | Comparative | Comparative | Comparative |
|---|---|---|---|---|---|---|---|---|
| | 1 | 2 | 3 | 4 | 5 | Example 1 | Example 2 | Example 3 |
| Amount of | 339.3 | 339.3 | 339.3 | 339.3 | 339.3 | 339.3 | 189.2 | 244.7 |
| solvent (g) | | | | | | | | |
| Yield of silica | 12.5 | 12.1 | 12.0 | 12.6 | 12.0 | 13.3 | 1.4 | 1.4 |
| particle (g) | | | | | | | | |
| Yield of silica | 3.68 | 3.57 | 3.54 | 3.71 | 3.54 | 3.92 | 0.72 | 0.57 |
| particle per | | | | | | | | |
| amount of | | | | | | | | |
| solvent (%) | | | | | | | | |
| Particle shape | Spherical | Spherical | Spherical | Almost | Spherical | Spherical | Spherical | Spherical |
| | | | | spherical | | | | |
| Average particle | 101 | 139 | 122 | 171 | 118 | 112 | 1,230 | 405 |
| diameter (nm) | | | | | | | | |
| Average pore | 1.5 | 1.8 | 1.8 | 2.2 | 1.8 | No pore | 3.6 | 3.6 |
| diameter (nm) | | | | | | | | |
| Specific surface | 43 | 757 | 216 | 563 | 225 | 29 | 589 | 668 |
| area (m²/g) | | | | | | | | |

Table 1 indicates that in Examples 1 to 5 using the method for producing porous silica particles of the present invention, the yield of porous silica particles per amount of the solvent is 3.54 to 3.71% and is about 5 to 7 times as high as 0.72% and 0.57% of Comparative Examples 2 and 3, respectively. This revealed that the method for producing porous silica particles of the present invention is characterized by being capable of producing porous silica particles with very high efficiency.

It was also found that the porous silica particles produced by the method for producing porous silica particles of the present invention are particles having a small average particle diameter of about 100 nm and are porous silica particles having micropores having an average pore diameter of 1.5 to 2.2 nm. It was thus found that the porous silica particles are optimum as a material for a low-refractive-index layer of an antireflection coating.

On the other hand, in Comparative Example 1 not using alkylamine, the particle shape and average particle diameter were substantially the same as those produced by the production method of the present invention in Examples 1 to 3. However, it was found that there is the problem of the absence of pores on the surfaces of the produced silica particles.

It was also found that Comparative Example 2 not using ammonia water has the problem causing a yield per solvent amount of as low as 0.72% and producing the porous silica particles having a very large average particle diameter of 1,230 nm.

It was also found that Comparative Example 3 not using ammonia water but using alkylamine in an amount larger than that in Comparative Example 2 has the problem causing a yield per solvent amount of as low as 0.57% and producing the porous silica particles having a large average particle diameter of 405 nm.

It was also found that Comparative Example 4 performed in the same manner as in Example 1 except that ammonia water was not used has the problem of producing very small particles after reaction and causing difficulty in separating the particles from the reaction solvent because of the very small particles and causing very low storage stability due to high reactivity, thereby failing to produce porous silica particles due to gelling.

In Comparative Example 5, silica fine particles were produced by the method described in Patent Literature 2 (Japanese Unexamined Patent Application Publication No. 2006-176343), and only silica fine particles having a particle diameter of as large as 4.7 μm could be produced.

### Example 6

### Synthesis of Porous Silica Particles Surface-Modified with Silazane Compound

First, 5 g of the porous silica particles produced in Example 1 was mixed with 44.5 g of isopropanol and then dispersed for 5 minutes with an output of 300 W using an ultrasonic homogenizer (“US-600T” manufactured by Nihonseiki Kaisha Ltd.). Then, 0.5 g of acetic acid and 0.5 g of hexamethyldisilazne (abbreviated as “HMDS” hereinafter) were added to the resultant dispersion and then dispersed at a processing pressure of 130 MPa for 30 minutes using a wet jet mill (“Nano Jet Pal JN-10” manufactured by Jokoh Co., Ltd.). The resultant dispersion was placed in a 200 mL four-neck flask provided with a thermometer and a stirring blade and heated under reflux for 60 minutes. The reaction solution was centrifuged at 10,000 rpm for 10 minutes, and then a supernatant was discarded to produce precipitates. Then, 50 g of isopropanol was added to the precipitates and dispersed with an output of 300 W for 5 minutes using an ultrasonic homogenizer (“US-600T” manufactured by Nihonseiki Kaisha Ltd.), and the dispersion was filtered with No. 5C filter paper and a Kiriyama funnel (manufactured by Kiriyama Glass Co.) to produce a dispersion of porous silica particles (E1) at a solid content of 7.9% by mass.

The porous silica particles (E1) in the dispersion of the porous silica particles (E1) produced as described above had a volume-average diameter of 102 nm and a coefficient of variation of 28%.

### Example 7

### Same as Above

First, 5 g of the porous silica particles produced in Example 2 was mixed with 44.5 g of isopropanol and then dispersed for 5 minutes with an output of 300 W using an ultrasonic homogenizer (“US-600T” manufactured by Nihonseiki Kaisha Ltd.). Then, 0.5 g of acetic acid and 0.5 g of HMDS were added to the resultant dispersion and then dispersed at a processing pressure of 130 MPa for 30 minutes using a wet jet mill (“Nano Jet Pal JN-10” manufactured by Jokoh Co., Ltd.). The resultant dispersion was placed in a 200 mL four-neck flask provided with a thermometer and a stirring blade and heated under reflux for 60 minutes. The reaction solution was centrifuged at 10,000 rpm for 10 minutes, and then a supernatant was discarded to produce precipitates. Then, 50.0 g of isopropanol was added to the precipitates and dispersed with an output of 300 W for 5 minutes using an ultrasonic homogenizer (“US-600T” manufactured by Nihonseiki Kaisha Ltd.), and the dispersion was filtered with No. 5C filter paper and a Kiriyama funnel (manufactured by Kiriyama Glass Co.) to produce a dispersion of porous silica particles (E2) at a solid content of 7.8% by mass.

The porous silica particles (E2) in the dispersion of the porous silica particles (E2) produced as described above had a volume-average diameter of 148 nm and a coefficient of variation of 28%.

### Example 8

### Same as Above

First, 5 g of the porous silica particles produced in Example 3 was mixed with 44.5 g of isopropanol and then dispersed for 5 minutes with an output of 300 W using an ultrasonic homogenizer (“US-600T” manufactured by Nihonseiki Kaisha Ltd.). Then, 0.5 g of acetic acid and 0.5 g of HMDS were added to the resultant dispersion and then dispersed at a processing pressure of 130 MPa for 30 minutes using a wet jet mill (“Nano Jet Pal JN-10” manufactured by Jokoh Co., Ltd.). The resultant dispersion was placed in a 200 mL four-neck flask provided with a thermometer and a stirring blade and heated under reflux for 60 minutes. The reaction solution was centrifuged at 10,000 rpm for 10 minutes, and then a supernatant was discarded to produce precipitates. Then, 50 g of isopropanol was added to the precipitates and dispersed with an output of 300 W for 5 minutes using an ultrasonic homogenizer (“US-600T” manufactured by Nihonseiki Kaisha Ltd.), and the dispersion was filtered with No. 5C filter paper and a Kiriyama funnel (manufactured by Kiriyama Glass Co.) to produce a dispersion of porous silica particles (E3) at a solid content of 7.9% by mass.

The porous silica particles (E3) in the dispersion of the porous silica particles (E3) produced as described above had a volume-average diameter of 139 nm and a coefficient of variation of 22%.

### Example 9

### Same as Above

First, 5 g of the porous silica particles after firing produced in Example 3 was mixed with 44.5 g of isopropanol and then dispersed for 5 minutes with an output of 300 W using an ultrasonic homogenizer (“US-600T” manufactured by Nihonseiki Kaisha Ltd.). Then, 0.5 g of acetic acid and 2.1 g of HMDS were added to the resultant dispersion and then dispersed at a processing pressure of 130 MPa for 30 minutes using a wet jet mill (“Nano Jet Pal JN-10” manufactured by Jokoh Co., Ltd.). The resultant dispersion was placed in a 200 mL four-neck flask provided with a thermometer and a stirring blade and heated under reflux for 60 minutes. The reaction solution was centrifuged at 10,000 rpm for 10 minutes, and then a supernatant was discarded to produce precipitates. Then, 50 g of isopropanol was added to the precipitates and dispersed with an output of 300 W for 5 minutes using an ultrasonic homogenizer (“US-600T” manufactured by Nihonseiki Kaisha Ltd.), and the dispersion was filtered with No. 5C filter paper and a Kiriyama funnel (manufactured by Kiriyama Glass Co.) to produce a dispersion of porous silica particles (E4) at a solid content of 8.0% by mass.

The porous silica particles (E4) in the dispersion of the porous silica particles (E4) produced as described above had a volume-average diameter of 127 nm and a coefficient of variation of 32%.

### Example 10

### Same as Above

First, 5 g of the porous silica particles after firing produced in Example 3 was mixed with 44.5 g of isopropanol and then dispersed for 5 minutes with an output of 300 W using an ultrasonic homogenizer (“US-600T” manufactured by Nihonseiki Kaisha Ltd.). Then, 0.5 g of acetic acid and 0.03 g of HMDS were added to the resultant dispersion and then dispersed at a processing pressure of 130 MPa for 30 minutes using a wet jet mill (“Nano Jet Pal JN-10” manufactured by Jokoh Co., Ltd.). The resultant dispersion was placed in a 200 mL four-neck flask provided with a thermometer and a stirring blade and heated under reflux for 60 minutes. The reaction solution was centrifuged at 10,000 rpm for 10 minutes, and then a supernatant was discarded to produce precipitates. Then, 50 g of isopropanol was added to the precipitates and dispersed with an output of 300 W for 5 minutes using an ultrasonic homogenizer (“US-600T” manufactured by Nihonseiki Kaisha Ltd.), and the dispersion was filtered with No. 5C filter paper and a Kiriyama funnel (manufactured by Kiriyama Glass Co.) to produce a dispersion of porous silica particles (E5) at a solid content of 8.0% by mass.

The porous silica particles (E5) in the resultant dispersion of the porous silica particles (E5) had a volume-average diameter of 110 nm and a coefficient of variation of 33%.

TABLE 2

| | Example 6 | Example 7 | Example 8 | Example 9 | Example 10 |
|---|---|---|---|---|---|
| Type of silica particle | Porous silica | Porous silica | Porous silica | Porous silica | Porous silica |
| | (E1) | (E2) | (E3) | (E4) | (E5) |
| Type of surface modifying agent | HMDS | HMDS | HMDS | HMDS | HMDS |
| Amount of surface modifying amount | 10 | 10 | 10 | 42 | 0.6 |
| used (parts by mass) (relative to | | | | | |
| 100 parts by mass of silica particle) | | | | | |
| Shape | Spherical | Spherical | Spherical | Spherical | Spherical |
| Volume-average diameter [MV] (nm) | 102 | 148 | 139 | 127 | 110 |
| Standard deviation (nm) | 29 | 42 | 31 | 41 | 36 |
| Coefficient of variation [CV] (%) | 28 | 28 | 22 | 32 | 33 |
| Peak of pore size distribution (nm) | 1.5 | 1.8 | 1.8 | 1.8 | 1.8 |
| Specific surface area (m²/g) | 43 | 757 | 216 | 216 | 221 |

### Example 11

A composition (1) for an antireflection coating was prepared by uniformly mixing 722 parts by mass of the dispersion of the porous silica particles (E1) produced in Example 1 (containing 57 parts by mass of the porous silica particles (E1)), 1,200 parts by mass of hexafunctional urethane acrylate (produced by reaction between 1 mole of isophorone diisocyanate and 2 moles of pentaerythritol triacrylate), 60 parts by mass of a photopolymerization initiator (“Irgacure 754” manufactured by BASF Japan Ltd.; oxyphenyl acetic acid-based photopolymerization initiator: mixture of 2-[2-oxo-2-phenylacetoxyethoxy]ethyl ester and 2-(2-hydroxyethoxy)ethyl ester), and 4,118 parts by mass of isopropanol.

### Example 12

A composition (2) for an antireflection coating was prepared by the same method as in Example 6 except that in place of 722 parts by mass of the dispersion of the porous silica particles (E1) used in Example 11, 731 parts by mass of the dispersion of the porous silica particles (E2) produced in Example 7 (containing 57 parts by mass of the porous silica particles (E2)) was used, and 4,118 parts by mass of isopropanol was changed to 4,109 parts by mass.

### Example 13

A composition (3) for an antireflection coating was prepared by the same method as in Example 6 except that in place of 722 parts by mass of the dispersion of the porous silica particles (E1) used in Example 11, 722 parts by mass of the dispersion of the porous silica particles (E3) produced in Example 8 (containing 9 parts by mass of the porous silica particles (E3)) was used.

### Example 14

A composition (4) for an antireflection coating was prepared by the same method as in Example 6 except that in place of 722 parts by mass of the dispersion of the porous silica particles (E1) used in Example 11, 713 parts by mass of the dispersion of the porous silica particles (E4) produced in Example 9 (containing 57 parts by mass of the porous silica particles (E4)) was used, and 4,118 parts by mass of isopropanol was changed to 4,127 parts by mass.

### Example 15

A composition (5) for an antireflection coating was prepared by the same method as in Example 6 except that in place of 722 parts by mass of the dispersion of the porous silica particles (E1) used in Example 11, 713 parts by mass of the dispersion of the porous silica particles (E5) produced in Example 10 (containing 57 parts by mass of the porous silica particles (E5)) was used, and 4,118 parts by mass of isopropanol was changed to 4,127 parts by mass.

### [Measurement of Reflectance]

The cured coating film formed as described above was scanned with a spectrophotometer (“U-4100 model” manufactured by Hitachi High Technologies Co., Ltd.) from a start wavelength of 800 nm to an end wavelength of 350 nm at a scan speed of 300 nm/min to measure reflectance under the measurement condition of a sampling interval of 0.50 nm. The reflectance was measured at a portion (bottom) with lowest reflectance. The measurement results of reflectance are shown in Table 3.

TABLE 3

| | Example 11 | Example 12 | Example 13 | Example 14 | Example 15 |
|---|---|---|---|---|---|
| Type of silica particle | Porous silica | Porous silica | Porous silica | Porous silica | Porous silica |
| | (E1) | (E2) | (E3) | (E4) | (E5) |
| Type of active-energy-ray | Composition | Composition | Composition | Composition | Composition |
| curable composition | (1) | (2) | (3) | (4) | (5) |
| Reflectance (%) | 3.3 | 3.0 | 3.0 | 3.2 | 3.4 |

### [Formation of Antireflection Film for Observation of Sectional Shape]

Each of the compositions (1) to (6) for an antireflection coating prepared as described above was applied using wire bar coater #22 onto a polyethylene terephthalate film (abbreviated as a “PET film” hereinafter) having a thickness of 188 μm and subjected to easily-adhesive surface treatment, dried at 25° C. for 1 minute, and then dried in a dryer at 60° C. for 5 minutes. Then, the composition was cured using an ultraviolet curing apparatus (in an air atmosphere, a metal halide lamp, ultraviolet irradiation of 2 kJ/m²) to form an antireflection film.

### [Observation of Section of Antireflection Film]

An ultrathin section of the antireflection film formed as described above was formed with an ultra microtome and observed with a transmission electron microscope (“JEM-2200FS” manufactured by JEOL, Ltd.) at an acceleration voltage of 200 kV and at 50,000× or 100,000×. The results of observation were as described below.

### [Results of Sectional Observation of Antireflection Film Using Composition (1) for Antireflection Coating]

A layer having a thickness of about 100 nm and containing the porous silica particles (E1) arranged in substantially a monolayer was formed on the surface opposite to the PET film (substrate).

### [Results of Sectional Observation of Antireflection Film Using Composition (2) for Antireflection Coating]

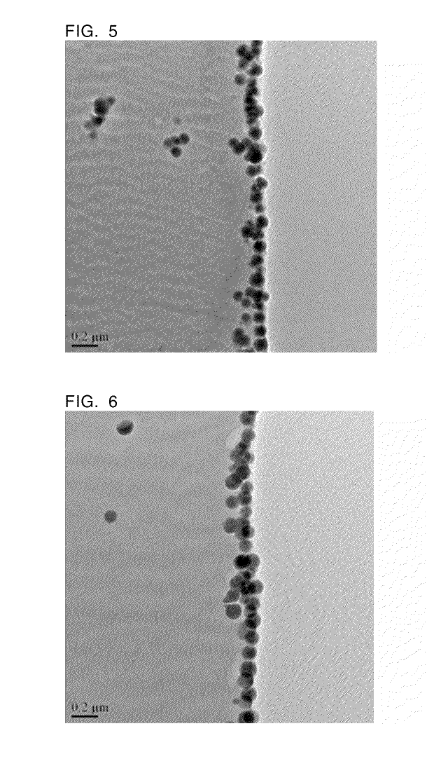

A layer having a thickness of about 150 nm and containing the porous silica particles (E2) arranged in substantially a monolayer was formed on the surface opposite to the PET film (substrate). FIG. 5 shows a photograph of the section. The left side of the photograph is the substrate side.

### [Results of Sectional Observation of Antireflection Film Using Composition (3) for Antireflection Coating]

A layer having a thickness of about 140 nm and containing the porous silica particles (E3) arranged in substantially a monolayer was formed on the surface opposite to the PET film (substrate). FIG. 6 shows a photograph of the section. The left side of the photograph is the substrate side.

### [Results of Sectional Observation of Antireflection Film Using Composition (4) for Antireflection Coating]

A layer having a thickness of about 140 nm and containing the porous silica particles (E4) arranged in substantially a monolayer was formed on the surface opposite to the PET film (substrate). FIG. 7 shows a photograph of the section. The left side of the photograph is the substrate side.

### [Results of Sectional Observation of Antireflection Film Using Composition (5) for Antireflection Coating]

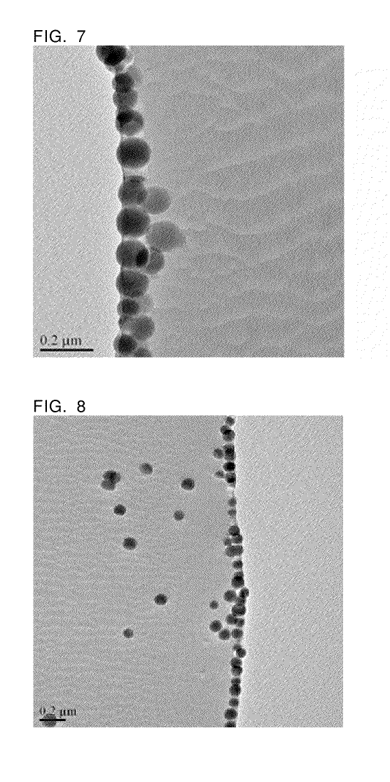

A layer having a thickness of about 140 nm and containing the porous silica particles (E5) arranged in substantially a monolayer was formed on the surface opposite to the PET film (substrate). FIG. 8 shows a photograph of the section. The left side of the photograph is the substrate side.

1. A method for producing porous silica particles having pores on the surfaces thereof, the method comprising a step of producing silica particles by adding a mixed solution (solution A) which contains tetraalkoxysilane, alkylamine, and alcohol to a mixed solution (solution B) which contains ammonia, alcohol, and water and performing a hydrolysis and condensation reaction of the tetraalkoxysilane, and a step of removing the alkylamine from the silica particles.

2. The method for producing porous silica particles according to claim 1, wherein the alkylamine is an amine compound containing an alkyl group having 6 to 18 carbon atoms.

3. The method for producing porous silica particles according to claim 1, wherein the alcohol is at least one alcohol selected from the group consisting of methanol, ethanol, and propanol.

4. The method for producing porous silica particles according to claim 1, wherein the tetraalkoxysilane is at least one tetraalkoxysilane selected from the group consisting of tetramethoxysilane, tetraethoxysilane, and tetrapropoxysilane.

5. The method for producing porous silica particles according to claim 1, wherein the step of producing silica particles includes a step of further adding a mixed solution (solution A′) containing tetraalkoxysilane and alcohol after the solution A is added to the solution B.

6. The method for producing porous silica particles according to claim 1, wherein the step of removing the alkylamine includes a step of removing the alkylamine by heating the silica particles.

7. The method for producing porous silica particles according to claim 1, wherein a ratio [tetraalkoxysilane/alkylamine] of the tetraalkoxysilane to the alkylamine in the solution A is in a range of 1/0.05 to 1/5 in terms of molar ratio.

8. The method for producing porous silica particles according to claim 1, wherein the content of the tetraalkoxysilane in the solution A is 10 to 60 parts by mass in 100 parts by mass of the solution A.

9. The method for producing porous silica particles according to claim 1, wherein a ratio [(water)/(tetraalkoxysilane)] of the amount of water in the solution B to the tetraalkoxysilane in the solution A is 0.5 to 25 in terms of molar ratio.

10. The method for producing porous silica particles according to claim 1, comprising a step of modifying the surfaces of the silica particles produced after the step of removing alkylamine from the silica particles.

11. The method for producing porous silica particles according to claim 10, wherein a surface treatment agent used for the surface modification is hexamethyldisilazane.

12. A resin composition for an antireflection coating, the resin composition comprising porous silica particles produced by the production method according to claim 11 and a binder resin.

13. An article comprising an antireflection coating formed by coating a substrate with the composition for an antireflection coating according to claim 12.

14. An antireflection film comprising an antireflection coating formed by coating at least one surface of a substrate film with the composition for an antireflection coating according to claim 12.

15. The method for producing porous silica particles according to claim 2, wherein the tetraalkoxysilane is at least one tetraalkoxysilane selected from the group consisting of tetramethoxysilane, tetraethoxysilane, and tetrapropoxysilane.

16. The method for producing porous silica particles according to claim 3, wherein the tetraalkoxysilane is at least one tetraalkoxysilane selected from the group consisting of tetramethoxysilane, tetraethoxysilane, and tetrapropoxysilane.

17. The method for producing porous silica particles according to claim 2, wherein the step of producing silica particles includes a step of further adding a mixed solution (solution A′) containing tetraalkoxysilane and alcohol after the solution A is added to the solution B.

18. The method for producing porous silica particles according to claim 3, wherein the step of producing silica particles includes a step of further adding a mixed solution (solution A′) containing tetraalkoxysilane and alcohol after the solution A is added to the solution B.

19. The method for producing porous silica particles according to claim 4, wherein the step of producing silica particles includes a step of further adding a mixed solution (solution A′) containing tetraalkoxysilane and alcohol after the solution A is added to the solution B.

20. The method for producing porous silica particles according to claim 15, wherein the step of producing silica particles includes a step of further adding a mixed solution (solution A′) containing tetraalkoxysilane and alcohol after the solution A is added to the solution B.
